(19) United States
(12) Patent Application Publication
(10) Pub. No.: US 2021/0088164 A1
(43) Pub. Date: Mar. 25, 2021

(54) PUSH CONNECTOR WITH CONNECTION CONFIRMATION FEEDBACK

(71) Applicant: SIDUS TECHNOLOGIES, INC., West Bloomfield, MI (US)

(72) Inventor: Mordechai Lev, Bloomfield Hills, MI (US)

(73) Assignee: SIDUS TECHNOLOGIES, INC., West Bloomfield, MI (US)

(21) Appl. No.: 17/026,962

(22) Filed: Sep. 21, 2020

Related U.S. Application Data
(60) Provisional application No. 63/014,321, filed on Apr. 23, 2020.
(60) Provisional application No. 62/902,859, filed on Sep. 19, 2019.

(51) Int. Cl. F16L 37/091; G10K 15/04; G08B 7/06

(52) U.S. Cl. CPC F16L 37/091; F16L 2201/10; G08B 7/06; G10K 15/04

(57) ABSTRACT

An improved method of securing a pipe to a connector is provided that includes inserting an end of the pipe into the connector with sufficient force for the pipe to fully seat in the connector. The inventive improvement is generating an auditory signal, a visual signal, or combination thereof in response to pipe fully seating in the connector. The signal generation is provided by components within the connector itself or through resort to a sensing tool.

### RELATED APPLICATIONS

This application is a non-priority application that claims priority benefit of U.S. Provisional Ser. No. 63/014,321 filed 23 Apr. 2020; and U.S. Provisional Ser. No. 62/902,859 filed 19 Sep. 2019. the contents of which are hereby incorporated by reference.

### FIELD OF THE INVENTION

The present invention in general relates to tubular connectors and in particular to push connectors with a combination of audio, tactile, and visual feedback to confirm proper engagement between tubular members.

### BACKGROUND OF THE INVENTION

Tubular push connectors are available to join tubular members. FIGS. 1A and 1B show an existing push connector with circular grab rings each with a series of sharp teeth positioned in opposing ends of the cylinder of the push connector. The circular grab rings engage and retain a first and second tubular member that are inserted into the opposing ends of the push connector. While this push connector provides an airtight connection for transporting fluids illustratively including gases and fluids, this push connector and other push connectors lack a combination of audio, tactile, and visual feedback to confirm proper engagement between tubular members.

There is a continuing need for improved tubular push connectors that provide a combination of audio, tactile, and visual feedback to confirm proper engagement between tubular members.

### SUMMARY OF THE INVENTION

An improved method of securing a pipe to a connector is provided that includes inserting an end of the pipe into the connector with sufficient force for the pipe to fully seat in the connector. The inventive improvement is generating an auditory signal, a visual signal, or combination thereof in response to pipe fully seating in the connector. The signal generation is provided by components within the connector itself or through resort to a sensing tool.

### BRIEF DESCRIPTION OF THE DRAWINGS

The application file contains at least one drawing executed in color. Copies of this patent application publication with color drawings will be provided by the Office upon request and payment of the necessary fee.

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which like reference numerals refer to like parts throughout the several views, and wherein:

FIGS. 1A and 1B illustrates a prior art push connector for joining tubular members;

FIGS. 2A and 2B are a cross sectional view of an inventive push connector with a collapsible springy pop up ring that provides an audio and tactile indication that the pipe is connected properly in accordance with an embodiment of the invention (FIG. 2A) while the dimpled washer and springy pop up ring are shown in magnified view (FIG. 2B);

FIGS. 3A-3C are a series cross sectional views of the push connector of FIG. 2 that illustrate the engagement steps of a pipe into the push connector in accordance with an embodiment of the invention from the pipe P′ not inserted (FIG. 3A), fully seated (FIG. 3B) and immediately before full insertion (FIG. 3C) to create an audio signal of fully seating as the domed washer is inverted;

FIGS. 4A-4C are a set of views of a push connector with a metal collapsible ring with fixed extension points in accordance with embodiments of the invention with the ring shown in cross section in the context of an inventive connector (FIG. 4A), a magnified view of the pipe prior to ring contact (FIG. 4B) and deforming interior tabs on the ring with contact (FIG. 4C);

FIGS. 5A-5C are a series cross sectional views of the push connector of FIGS. 4A-4C that illustrate the engagement steps of a pipe into the push connector in accordance with an embodiment of the invention;

FIG. 6 is a cross sectional view of a push connector with a colored slider engagement indicator in accordance with embodiments of the invention;

FIGS. 7A-7D are a series cross sectional views of the push connector of FIG. 6 that illustrates the engagement steps of a pipe into the push connector in accordance with an embodiment of the invention;

FIGS. 8A-8D are a set of views of an inventive push connector with an expanding snap ring in accordance with embodiments of the invention;

FIG. 9 is a cross sectional view of the push connector of FIGS. 8A-8D that illustrates two pipes joined together in accordance with embodiments of the invention;

FIGS. 10A-10C are an interior view (FIG. 10A) of a mechanical indicator tool, and the visual state of the tool engaging an inventive connector with a pipe fully seated (FIG. 10B) and unseated (FIG. 10C);

FIGS. 11A-11E are an interior view (FIG. 11A) of an electronic indicator tool, and the visual state of the tool engaging an inventive connector with a pipe not fully seated in perspective (FIG. 11B) and cross section (FIG. 11D) and the pipe fully seated in perspective (FIG. 11C) and cross section (FIG. 11E);

FIGS. 12A and 12B are successive cross section views a push connector with a spring mounted magnet in accordance with embodiments of the invention for operation with an indicator tool;

FIGS. 13A-13E are a perspective view (FIG. 11A) of a magnet containing connector providing a visual indication of pipe seating status with a pipe not fully seated in and cross section (FIG. 13D) and the pipe fully seated in cross sectional perspective (FIG. 13E), and the with the magnet housing show in magnified perspective partially transparent view (FIG. 13B) and exploded view (FIG. 13C); and

FIGS. 14A-14C are a persepctive view of an inventive push connector with a slide providing a visual indication that the pipe is connected properly in accordance with an embodiment of the invention (FIG. 14A) while the relationship of the slide to an underlying metal bar and a ferromagnetic metal ring are shown in magnified view in not fully seated pipe position (FIG. 14B) and fully seated (FIG. 14C).

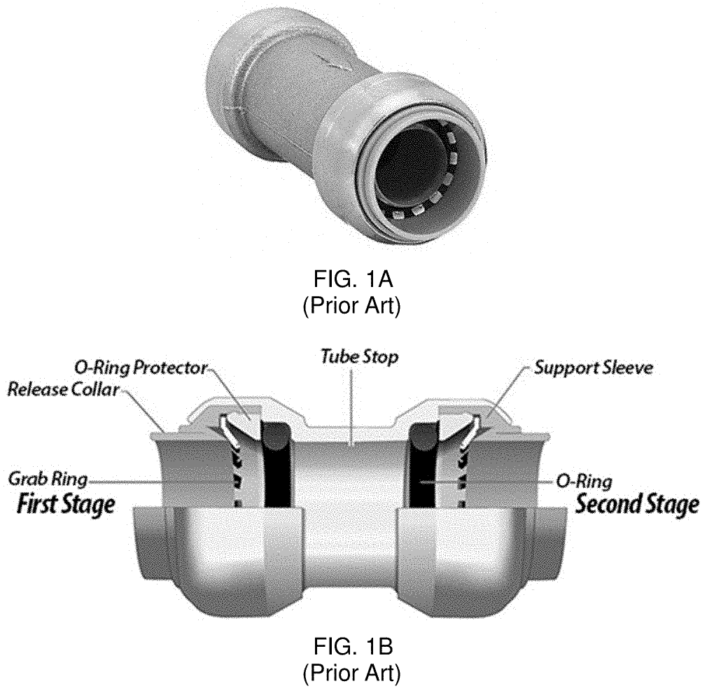

### DETAILED DESCRIPTION OF THE INVENTION

Embodiments of the invention provide tubular push connectors that provide a combination of audio, tactile, and visual feedback to confirm proper engagement between tubular members such a pipes. Embodiments of the inventive tubular push connectors provide an air and/or fluid tight connection for tubular members carrying fluids illustratively including gases and liquids.

While the present invention is further detailed herein with respect to a linear dual end connector, it is appreciated that the present invention is readily adapted to include single pipe-end cap, L-Shaped, and T-shaped connectors, as shown for example in US20030137148, SHARKBITE® connector U362LF.

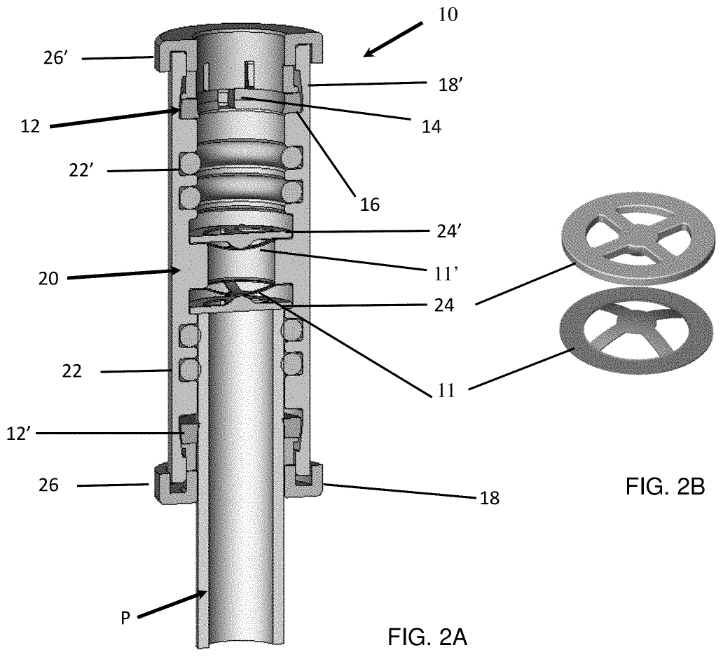

Referring now to the figures, FIG. 2 is a cross sectional view of an embodiment of an inventive push connector 10 with a collapsible springy ring 11 is able to invert around the plane or “pop” and provides an audio and tactile indication that the pipe is connected properly. Springy ring 11′ is shown in inverted form after being compressing by a dimpled washer 24′. The springy ring 11 is readily formed of spring steel and plastics able of providing an audio signal detected by an unaided normal human ear. It is noted that the lower half the connector 10 is a central cross-sectional view, while the upper portion depicts housing included portions in complete form. A metal ring 12 with circular grab rings 14 each with a series of sharp teeth 16 is positioned in opposing ends 18, 18′of the cylinder of the push connector 10. The circular grab rings 14 engage and retain a first or a first and second tubular member P, P′ that are inserted into the opposing ends of the push connector 10. The connector 10 is defined by a housing 20. The pipe P is circumferentially engaged by seals 22, 22′ and upon completely inserted contacts dimpled washers 24, 24′ after being inserted through caps 26, 26′. As the first and second tubular member are inserted further into the opposing ends of the push connector pressure is applied to the collapsible springy pop up ring that provides an audio and tactile indication that the pipe is connected properly. The washer 24 and the springy metal ring 11 are shown in magnified view in FIG. 2B.

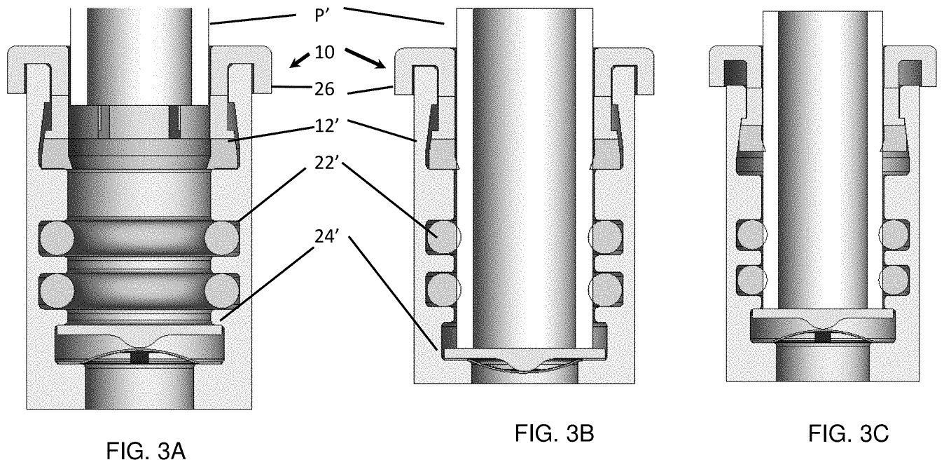

FIGS. 3A-3C are a series cross sectional views of the push connector of FIG. 2 that illustrate the engagement steps of a pipe into the push connector 10 where like numerals have the meaning ascribed thereto in the aforementioned drawings. In FIG. 3A, the pipe P′ is pushed into the push connector 10 and the circular grab ring 12′ engages the pipe P′. In FIG. 3B, the pipe P′ is pushed until the collapsible ring 12′ collapses providing audio and feel indication that the pipe P′ is connected properly. In FIG. 3C, the pipe is pulled outward until the cap is elevated, providing a visual good connection indication. It is noted that the collapsible ring bounces back to its normal position, ready for the next installation FIG. 3C is not labelled with reference numerals for visual clarity.

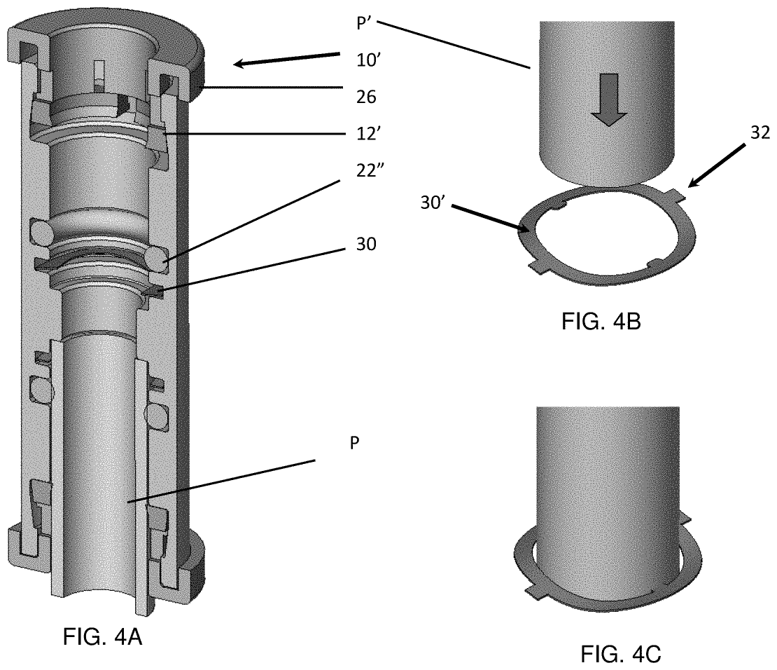

FIGS. 4A shows an embodiment of an inventive push connector 10′ with a metal collapsible ring 30 with four fixed teeth 32 and single seal 22″ where like numerals have the meaning ascribed thereto in the aforementioned drawings. FIGS. 4B and 4C show the successive insertion of a pipe P′ through the ring 12′. FIG. 4C is not labelled with reference numerals for visual clarity.

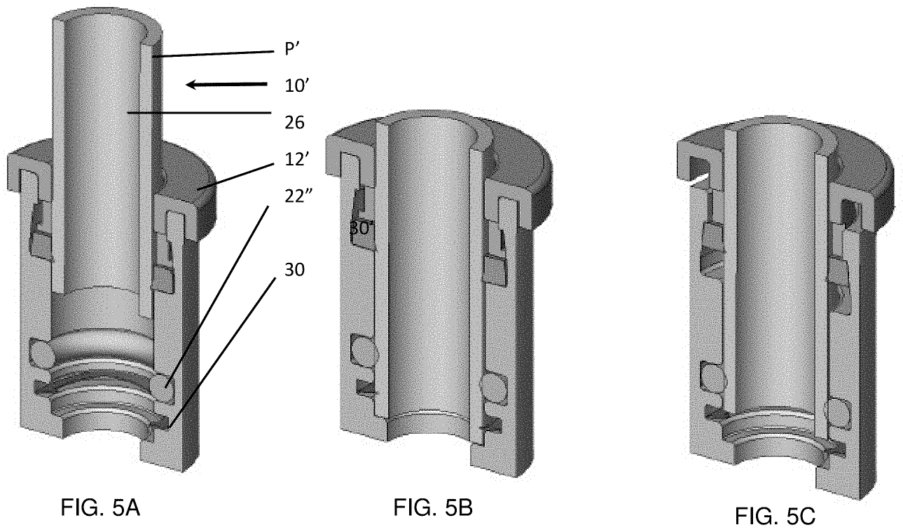

FIGS. 5A-5C are a series cross sectional views of the push connector of FIGS. 4A-4C that illustrate the engagement steps of a pipe into the push connector 10′ where like numerals have the meaning ascribed thereto in the aforementioned drawings. In FIG. 5A, the pipe is pushed into the connector and engages the grab ring. In FIG. 5B, the pipe is further pushed onto the collapsible ring and collapses the ring, providing audio and feel indication that the pipe is connected properly. In FIG. 5C, the pipe is pulled out until the cap is elevated thereby providing visual feedback of a good connection between the push connector and the inserted pipe. It is noted that the collapsible ring 30 is now detached from the pipe and ready for next installation. FIGS. 5B and 5C is not labelled with reference numerals for visual clarity.

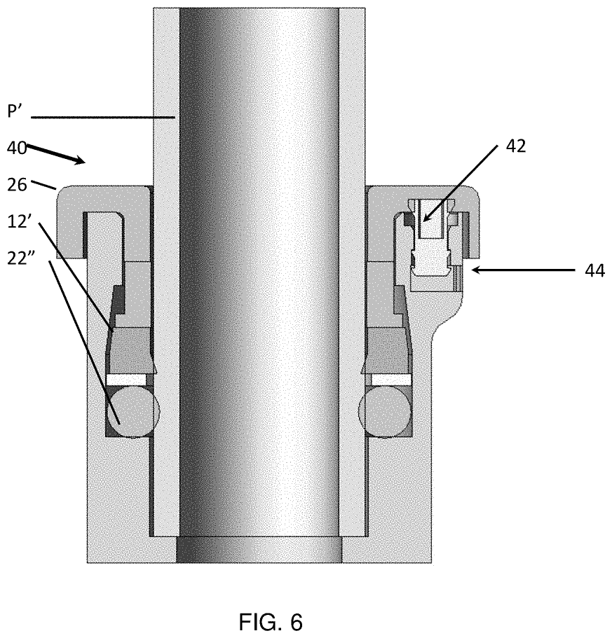

FIG. 6 is a cross sectional view of an embodiment of an inventive push connector 40 with a colored slider engagement indicator 42 that is displayed in a window 44 of the connector 40. As a result, the color observed in the window 44 provides a visual confirmation if a proper seal has been made to the pipe P′.

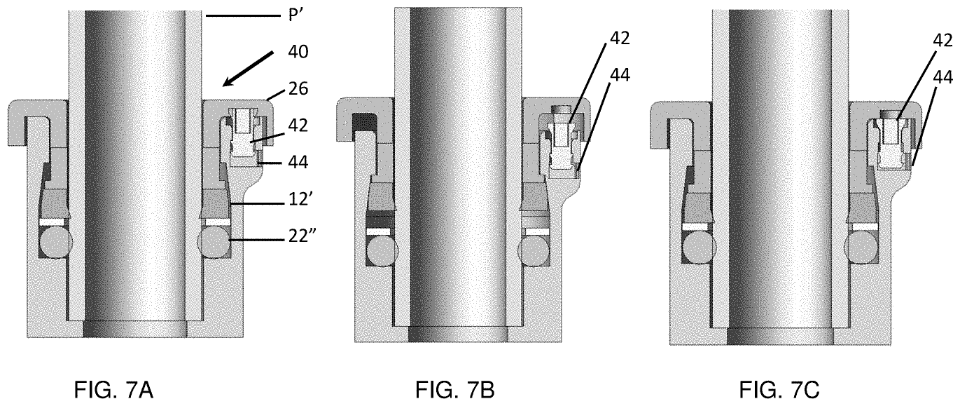

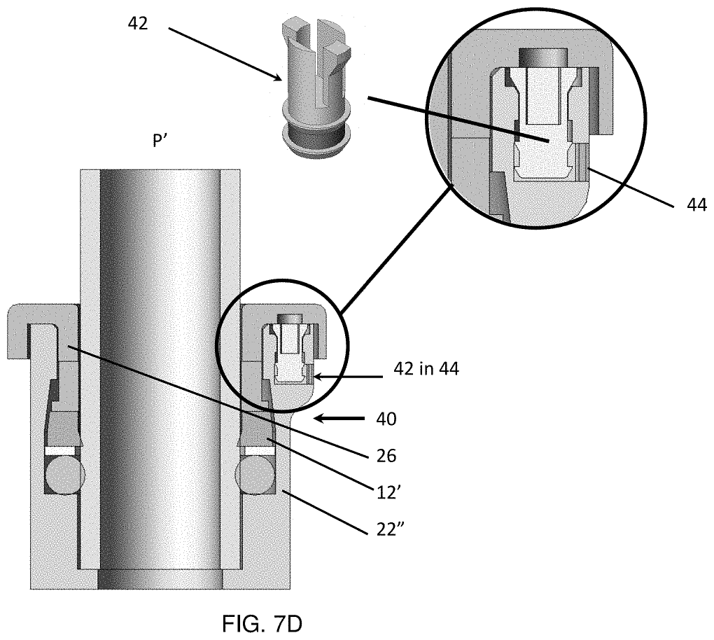

FIGS. 7A-7D are a series cross sectional views of the push connector of FIG. 6 that illustrates the engagement steps of a pipe into the push connector where like numerals have the meaning ascribed thereto in the aforementioned drawings. In FIG. 7A, the pipe is pushed all the way into the connector until hitting a physical stop. In FIG. 7B, the cap 26 of the connector is pulled upward and a colored slider separates from the cap and drops down. In FIG. 7C, the colored slider appears through a window in the connector that visually indicates a proper connection of the pipe to the connector. FIG. 7D is a detailed view of the colored slider and window for indicating the status of a connection. FIGS.7B and 7C is not labelled with all reference numerals for visual clarity.

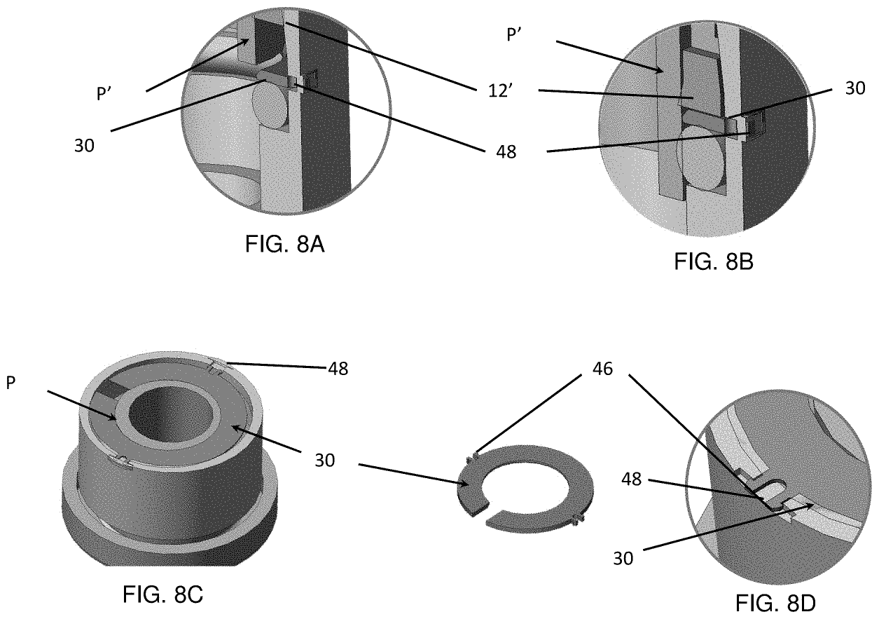

FIGS. 8A-8D are a set of magnified views of an inventive embodiment of a push connector with an expanding snap ring 30 as shown in FIGs, 4A-7D where like numerals have the meaning ascribed thereto in the aforementioned drawings. In FIG. 8A, pipe P′is pushed into the connector 10′ or 40 that causes the expansion of the snap ring 30 outwards or sideways as shown in FIG. 8B. As shown in FIGs, 8B-8D indicator legs 46 stick into a window slots 48 in the connector walls that provide a visual indication that the pipe P′ is fully inserted into the connector 10′ or 40.

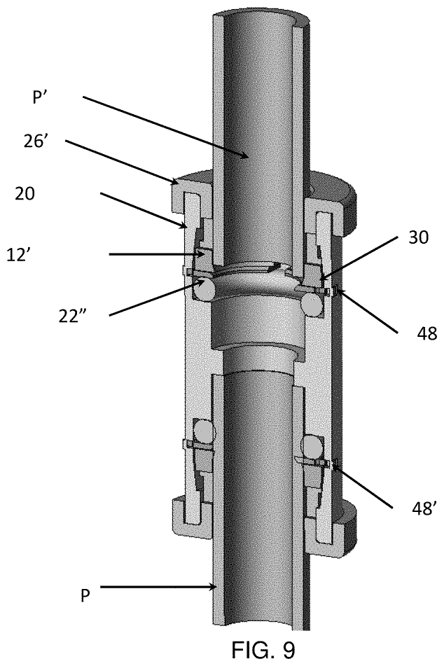

FIG. 9 is a cross sectional view of the push connector of FIGS. 8A-8D that illustrates two pipes joined together with the connector 10′ or 40 with the pipe P′ not full inserted and pipe P full inserted with an indictor change seen in 48′. Duplicate numerals are omitted from the bottom portion of FIG. 9 for visual clarity.

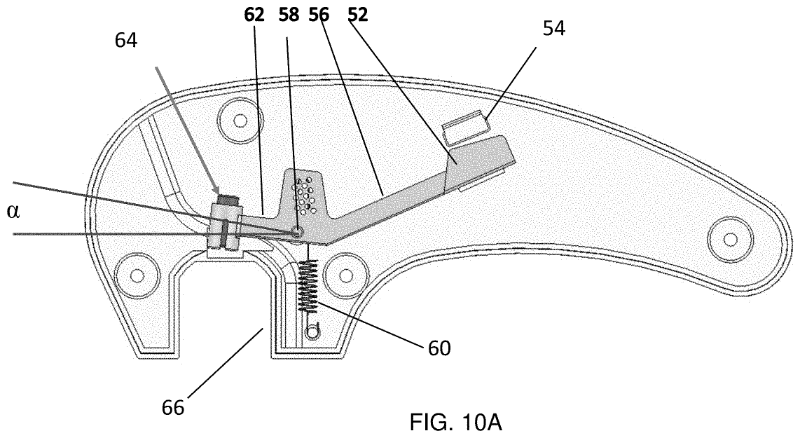

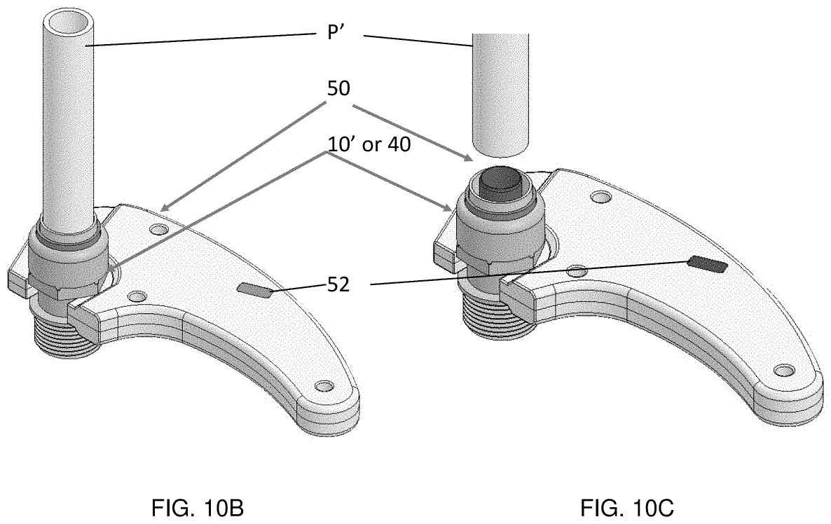

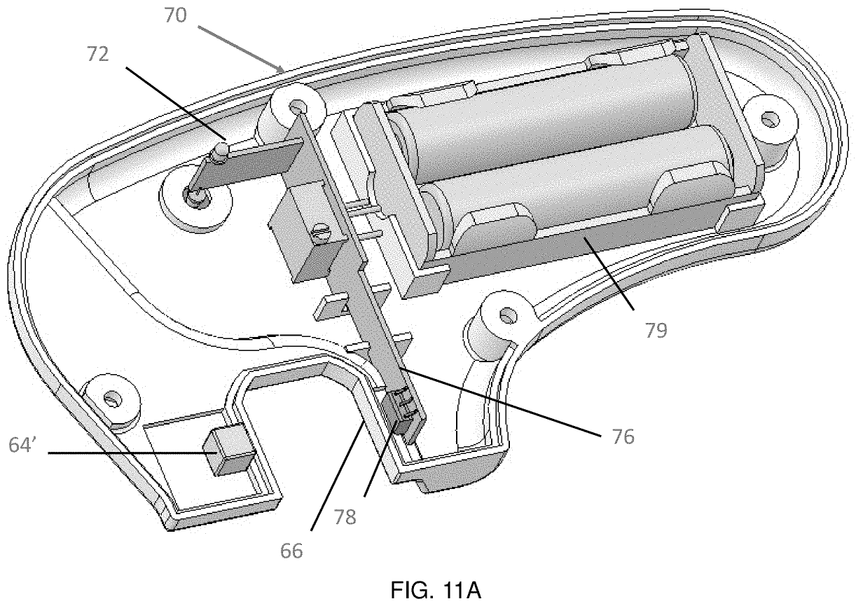

In FIGS. 10A-10C, a tool is shown generally at 50. A mechanical visual indicator 52 is visible through a validation window 54. As best seen in FIG. 10A, in which a portion of the cover is removed from tool 50, the mechanical visual indicator 52 is attached to a rocker arm 56 extending from a pivot point 58. The rocker arm 56 has a spring 60 that tensions the rocker arm 56 in an extreme position of “open” or “closed”. A second arm 62 extending from an opposing side relative to rocker arm 56. The second arm 62 includes a magnet 64 that is drawn towards a profile 66 adapted to engage the housing 20 when the ring 30 is pressed outward as the pipe P′ is fully engaged in the connector 10′ or 40. The magnet 64 exerts sufficient force to overcome the counter force applied by the spring 60 to change the angle a to shift the rocker arm 56 into overlapping alignment between the mechanical visual indicator 52 and the validation window 54. It is appreciated that different arm configurations provide a visual indication, such as a window positioned to visualize the magnet 64 movement. FIGS. 10B and 10C show the change in the validation window 54 indicative of the pipe P′ fully seated and not fully seated relative to an inventive corrector 10′ or 40, respectively and regardless of whether a window slot 48 is present therein.

It is appreciated that when magnetic sensing of a ring is the mechanism of visual indication of pipe seating that surround connector components are formed of materials that do not interfere with the magnetic interaction and therefore include diamagnetic and paramagnetic materials.

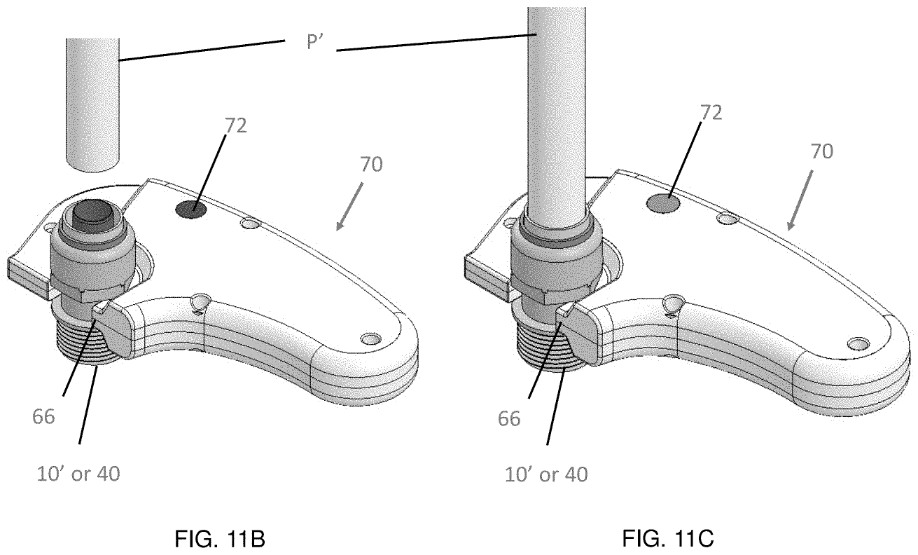

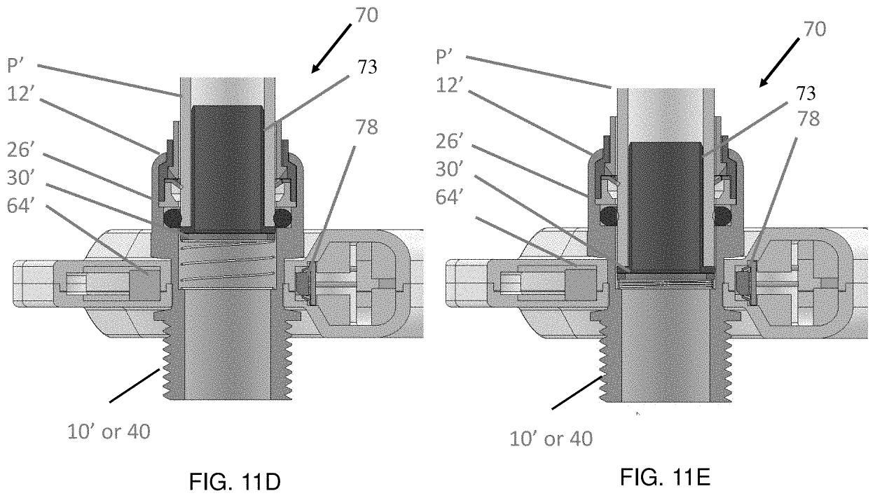

In FIGS. 11A-11E, a tool is shown generally at 70 where like numerals have the meaning ascribed thereto in the aforementioned drawings. A light emitting diode (LED) visual indicator 72 is visible through a validation window 74. As best seen in FIG. 11A, in which a portion of the cover is removed from tool 70, the LED visual indicator 72 is in electrical communication with a printed circuit board 76. A sensor 78 mounted proximal to the profile 64 is responsive to position of a magnet 64′. In operation, the magnet 64′ is responsive to the position of a ferromagnetic metal ring 30′ in a connector that in turn is response to pipe seating. The sensor 78 provides an electrical signal that selectively activates the LED visual indicator 72. A power source 79 is provided to operate the LED visual indicator 72 and sensor 78. It is appreciated that the magnet 64′ is a either a ferromagnetic material or an electromagnet and in electrical communication with the power source 79 as needed. FIGS. 11B and 11D show in perspective and cross-sectional views, respectively, the LED visual indicator 72 indicative of the pipe P′ not fully seated relative to an inventive corrector 10′ or 40 regardless of whether a window slot 48 is present therein. FIGS. 11C and 11E show in perspective and cross-sectional views, respectively, the LED visual indicator 72 indicative of the pipe P′ fully seated relative to an inventive corrector 10′ or 40 regardless of whether a window slot 48 is present therein. For example, a red LED light emission indicates not fully seated while a green LED light emission indicates fully seated. In some inventive embodiments, a flanged inner tube 73 adapted to be engage the end and inner wall of the pipe P′ is provided to protect the end of the pipe P′ during the compression process to a fully seated position shown in FIG. 11E. It is appreciated that an buzzer or other auditory device is present in the tool and typically associated with the printed circuit board 76 to provide auditory signal of full seating alone or in combination with visual signalling.

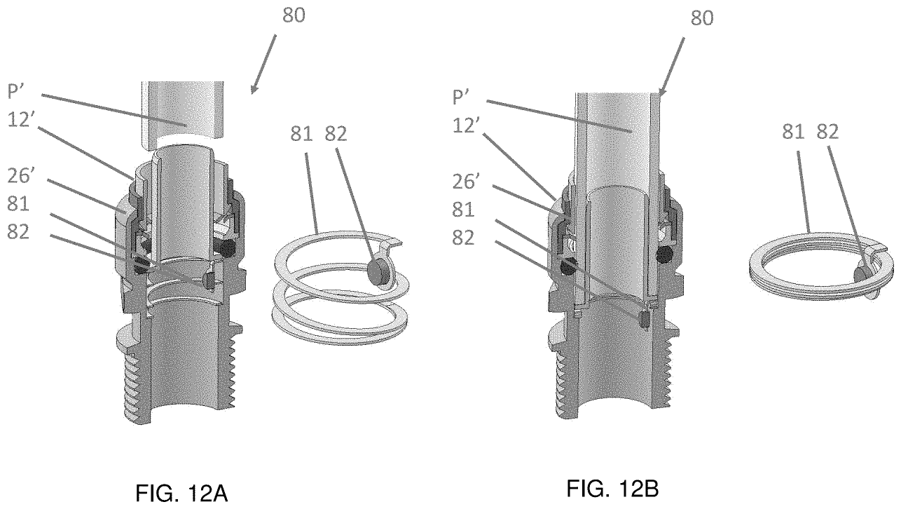

In an alternate embodiment, as shown in FIGS. 12A and 12B where like numerals have the meaning ascribed thereto in the aforementioned drawings, a connector 80 is provided in which the function of the magnet 64′ in tool 70 is performed by a spring 81 supporting a magnet 82. In operation, as the spring 81 is compressed by insertion of the pipe P′, thereby moving the magnet 82 into detection range of the sensor 78 of tool analogous to tool 70 that lacks magnet 64′

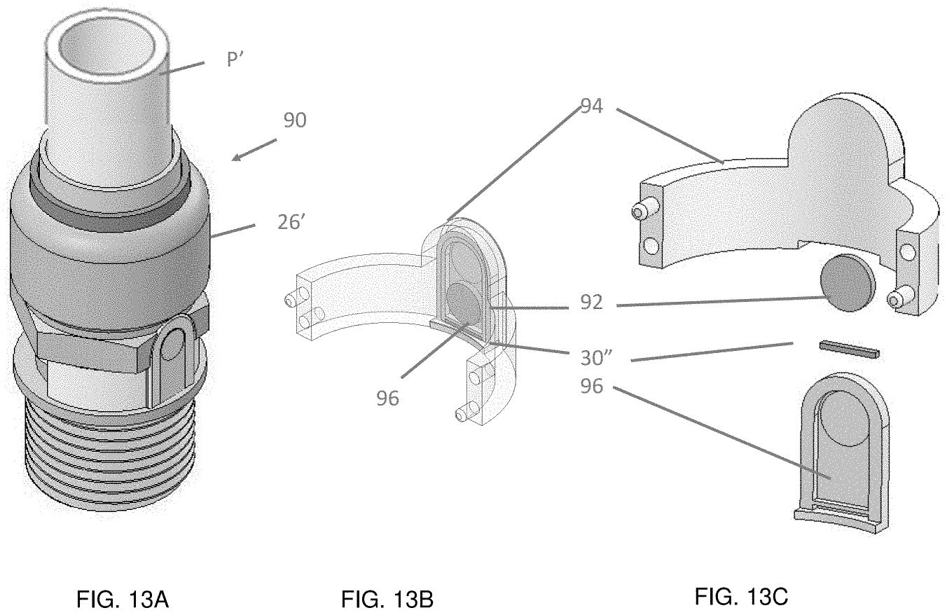

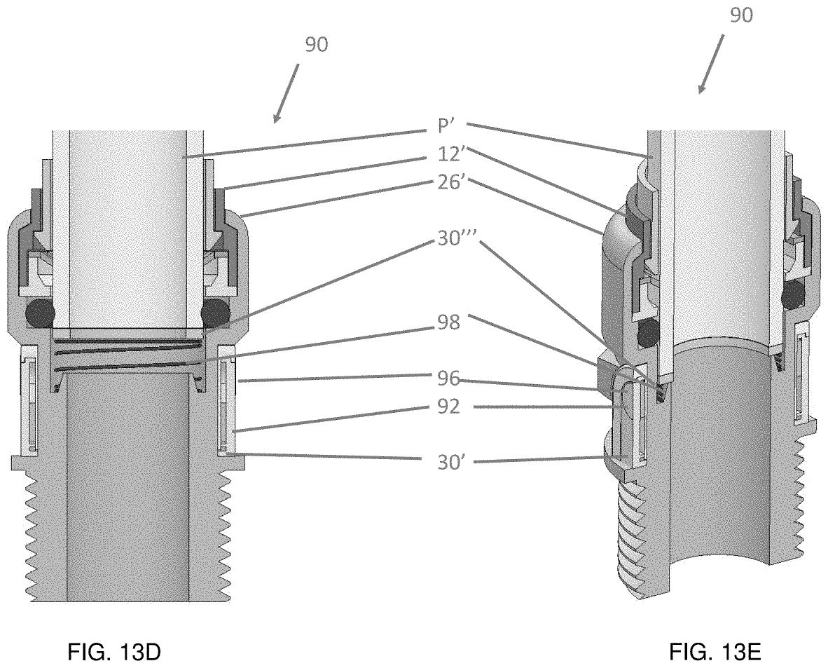

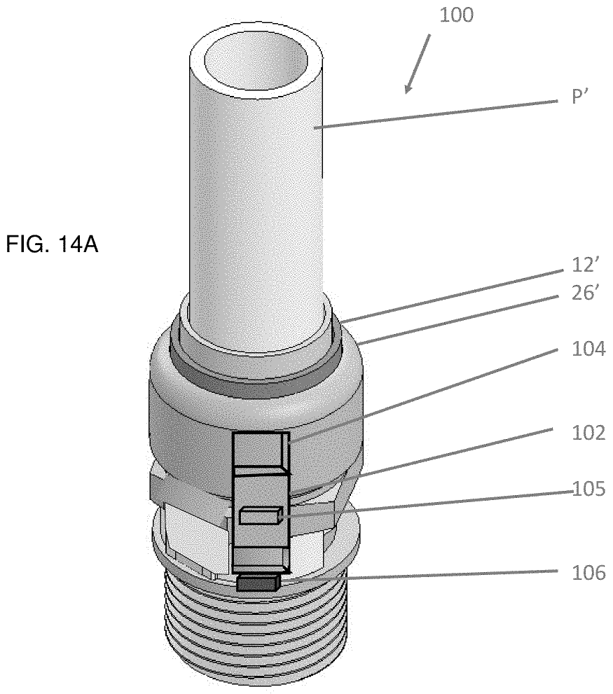

In an alternate embodiment, as shown in FIGS. 13A-13E where like numerals have the meaning ascribed thereto in the aforementioned drawings, a connector 90 is provided in which a magnet 92 is moved by the insertion of pipe P′ into the cap 12′ to create sufficient attraction between the magnet 92 and a second ferromagnetic metal ring 30′ relative to cause the magnet 92 to slide in a housing 94. The housing 94 includes a window 96 through which a user can observe whether the magnet 92 is aligned with the window 96. As best shown in FIGS. 13D and 13E, when a pipe P′ is not fully seated, magnet 92 is attracted to a second ferromagnetic ring 30′ thus stays in place and away from the window 96 that is shown above the magnet 94 in these depicted views. A first ferromagnetic ring 30″ attached to a spring 98 is too far away when the pipe P′ is not fully inserted to attract the magnet 92 upwards into the window 96. As shown in FIG. 13E, only when the pipe P′ is fully seated is the spring 98 compressed to bring first ferromagnetic ring 30″ into proximity with the magnet 92 to cause the magnet 92 to align and thus become visible in the window 96.

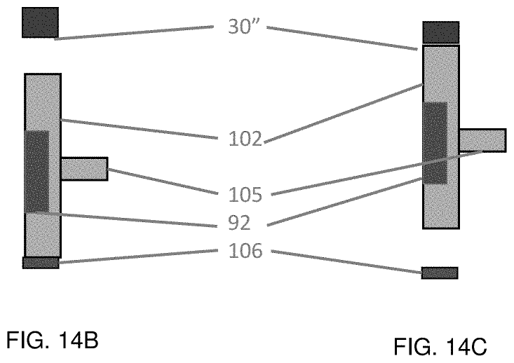

In an alternate embodiment, as shown in FIGS. 14A-14C where like numerals have the meaning ascribed thereto in the aforementioned drawings, a connector 100 is provided in which a slide 102 includes a magnet 92′ is free to move within a channel 104, the movement of which is associated with the insertion condition of pipe P′. The magnet 92′is attracted to a ferromagnetic metal block 106 prior to the pipe P′ being fully seated. After pipe P′ is inserted to what is believed to be a fully seated position, the user moves the slide 102 upward as depicted to the top of the channel 104. Optionally, a handle 105 is present. If the pipe P′ is actually fully seated, the slide 102 will attract to the first ferromagnetic ring 30″ and stay in place indicating full seating; otherwise, the slide 102 will move toward the metal block 106 indicating an incomplete seating. The unseated and fully seated relationship between the ferromagnetic block 106-slide 102—first ferromagnetic ring 30″ are illustrated schematically in FIGS. 14B and 14C, respectively.

The foregoing description is illustrative of particular embodiments of the invention but is not meant to be a limitation upon the practice thereof. The following claims, including all equivalents thereof, are intended to define the scope of the invention.

1. An improved method of securing a pipe to a connector that includes inserting an end of the pipe into the connector with sufficient force for the pipe to fully seat in the connector, wherein the improvement lies in:
generating an auditory signal, a visual signal, or combination thereof in response to pipe fully seating in the connector.

2. The improved method of claim 1 wherein the auditory signal is present and provided by a springy ring being inverted.

3. The improved method of claim 1 wherein the visual signal is present and provided by an object moving relative to a window in the connector.

4. The improved method of claim 1 wherein the object is a plastic piece detached from a cap of the connector.

5. The improved method of claim 1 wherein the object is a metal ring deformed to shown sticks from the metal ring.

6. The improved method of claim 1 wherein the object is a magnet within a slide.

7. The improved method of claim 1 wherein a further improvement lies in a tool having a profile shaped to receive a portion of the connector, the tool providing the auditory signal, the visual signal, or combination thereof.

8. The improved method of claim 7 wherein the tool comprises a magnet mechanical connected to a rocker arm with movement of the rocker arm provided the visual signal.

9. The improved method of claim 7 wherein the tool comprises a sensor that energizes a light emitting diode to provide the visual signal.

10. The improved method of claim 9 wherein the light emitting diode emits a first color as the visual signal and a second color if the pipe is not fully seated.

11. The improved method of claim 10 wherein the first color is green and the second color is red.
